(19) United States
(12) Patent Application Publication
(10) Pub. No.: US 2010/0110006 A1
(43) Pub. Date: May 6, 2010

(54) Remote pointing appratus and method

(75) Inventors: Gee Hyuk Lee, Daejeon-si (KR); Won-Chul Bang, Seongnam-si (KR); Byung Seok Soh, Hwaseong-si (KR); Yu Ri Ahn, Daejeon-si (KR); Hyong Euk Lee, Yongin-si (KR)

Correspondence Address: STAAS & HALSEY LLP, SUITE 700, 1201 NEW YORK AVENUE, N.W., WASHINGTON, DC, 20005, US

(73) Assignees: SAMSUNG ELECTRONICS CO., LTD, Suwon (KR); KOREA ADVANCED INSTITUTE OF SCIENCE AND TECHNOLOGY, Daejeon (KR)

(21) Appl. No.: 12/458,730

(22) Filed: Jul. 21, 2009

(30) Foreign Application Priority Data
Oct. 31, 2008 (KR) 10-2008-0107832

(51) Int. Cl. G06F 3/033

(52) U.S. Cl. 345/158

(57) ABSTRACT

A remote pointing apparatus is provided. A light receiving unit may receive emitted light. A filtering unit may filter a received signal to a first frequency component, a second frequency component, a third frequency component, and a fourth frequency component. A calculation unit may compare amplitudes of the first frequency component and the second frequency component to calculate a first coordinate axis value of a cursor on a display unit, and compare amplitudes of the third frequency component and the fourth frequency component to calculate a second coordinate axis value of the cursor on the display unit.

### CROSS-REFERENCE TO RELATED APPLICATIONS

This application claims the priority benefit of Korean Patent Application No. 10-2008-0107832, filed on Oct. 31, 2008, in the Korean Intellectual Property Office, the disclosure of which is incorporated herein by reference.

### BACKGROUND

1. Field

Exemplary embodiments relate to an infrared-ray (IR)-based pointing apparatus and method which controls a location of a cursor on a display.

2. Description of the Related Art

A pointing system controlling a location of a cursor on a display is currently the focus of attention due to the advent of an intelligent television (TV), and the like. In an initial model of the intelligent TV, an option provided on a display may be associated with a button of a remote control, or an activation portion on a screen may change using a direction button (left/right, top/bottom).

However, in a conventional art, a button may not effectively control a movement of a pointer/cursor on a display similar to a natural movement of a computer mouse. Accordingly, a method of naturally mapping a movement of a pointing apparatus to a movement of a pointer/cursor on a display, when a user moves the pointing apparatus, is required.

### SUMMARY

Additional aspects and/or advantages will be set forth in part in the description which follows and, in part, will be apparent from the description, or may be learned by practice of the disclosure.

Exemplary embodiments may provide a remote pointing apparatus and method which may reduce complexity of a circuit configuration and an effect of noise.

Exemplary embodiments may also provide a frequency-modulated remote pointing apparatus and method which may be utilized for quick calculations without a control signal.

According to exemplary embodiments, there may be provided a remote pointing apparatus, including: a light receiving unit to receive a first emitted light and a second emitted light emitted during a first half cycle, and a third emitted light and a fourth emitted light emitted during a second half cycle; and a calculation unit to compare amplitudes of the received first emitted light and the received second emitted light to calculate a first coordinate axis value of a cursor on a display unit, and compare amplitudes of the received third emitted light and fourth emitted light to calculate a second coordinate axis value of the cursor on the display unit.

The light receiving unit may receive a control signal emitted every cycle, and the calculation unit may divide a cycle into the first half cycle and the second half cycle based on a time that the control signal is received.

According to exemplary embodiments, the first emitted light and the second emitted light may have an identical cycle and an identical amplitude, and each of the first emitted light and the second emitted light may be a pulse train with a first phase difference of a first angle. Also, the third emitted light and the fourth emitted light may have an identical cycle and an identical amplitude, and each of the third emitted light and the fourth emitted light may be a pulse train with a second phase difference with a second angle. The first angle and the second angle may be 180 degrees.

According to other exemplary embodiments, the first emitted light may be a signal of a ramp downward sawtooth wave, the second emitted light may be a signal of an upward ramp sawtooth waveform, and the first emitted light and the second emitted light may have an identical cycle and an identical maximum amplitude. The downward ramp sawtooth waveform of the first emitted light and the upward ramp sawtooth waveform of the second emitted light may be embodied as a pulse train. In this instance, a phase difference between the pulse trains of the first emitted light and the second emitted light may be 180 degrees. When the amplitude of the first emitted light increases from 0 to a maximum amplitude, the amplitude of the second emitted light may decrease from a maximum amplitude to 0.

Also, the third emitted light may be a signal of a downward ramp sawtooth waveform, the fourth emitted light may be a signal of a upward ramp sawtooth waveform, and the third emitted light and the fourth emitted light may have an identical cycle and an identical maximum amplitude. The third emitted light and the fourth emitted light may be emitted after the control signal is generated, that is, a time of (t1−t0).

According to exemplary embodiments, the first emitted light may be a ramp downward pulse train signal, the second emitted light may be an upward ramp pulse train signal, and the calculation unit may calculate the first coordinate axis value of the cursor based on a time that intensities of the first emitted light and the second emitted light are identical.

The third emitted light may be a ramp downward pulse train signal, the fourth emitted light may be an upward ramp pulse train signal, and the calculation unit may calculate the second coordinate axis value of the cursor based on a time that intensities of the third emitted light and the fourth emitted light are identical.

According to still other exemplary embodiments, a remote pointing apparatus, including: a modulator to generate at least four emitted lights having a same amplitude and different frequencies; and at least four light emitting units to emit each of the at least four emitted lights.

The at least four emitted lights may include a first emitted light, a second emitted light, a third emitted light, and a fourth emitted light, and the first emitted light and the second emitted light may have a same amplitude and the third emitted light and the fourth emitted light may have a same amplitude. The first emitted light, the second emitted light, the third emitted light and the fourth emitted light may be an infrared-ray.

According to exemplary embodiments, a remote pointing apparatus, including: a filtering unit to filter a received signal to a first frequency component, a second frequency component, a third frequency component, and a fourth frequency component; and a calculation unit to compare amplitudes of the first frequency component and the second frequency component to calculate a first coordinate axis value of a cursor on a display unit, and compare amplitudes of the third frequency component and the fourth frequency component to calculate a second coordinate axis value of the cursor on the display unit.

According to exemplary embodiments, a remote pointing method, including: emitting a first emitted light and a second emitted light during a first half cycle; receiving the first emitted light and the second emitted light during the first half cycle and calculating a first coordinate axis value of a cursor on a display unit; emitting a third emitted light and a fourth emitted light during a second half cycle; and receiving the third emitted light and the fourth emitted light during the second half cycle and calculating a second coordinate axis value of the cursor on the display unit.

According to other exemplary embodiments, the remote pointing method may further include: emitting a control signal every cycle, wherein a cycle may be divided into the first half cycle and the second half cycle based on a time that the control signal is received.

According to still other exemplary embodiments, a remote pointing method, including: receiving a first emitted light modulated to a first frequency, a second emitted light modulated to a second frequency, a third emitted light modulated to a third frequency, and a fourth emitted light modulated to a fourth frequency in a light receiving unit; filtering the lights received in the light receiving unit to a first frequency component, a second frequency component, a third frequency component, and a fourth frequency component; and comparing amplitudes of the first frequency component and the second frequency component to calculate a first coordinate axis value of a cursor on a display unit, and comparing amplitudes of the third frequency component and the fourth frequency component to calculate a second coordinate axis value of the cursor on the display unit.

The first emitted light and the second emitted light may have a same amplitude and the third emitted light and the fourth emitted light may have a same amplitude.

### BRIEF DESCRIPTION OF THE DRAWINGS

These and/or other aspects of exemplary embodiments will become apparent and more readily appreciated from the following description, taken in conjunction with the accompanying drawings of which:

FIG. 1 is a diagram illustrating an apparatus for transmitting an emitted light according to exemplary embodiments;

FIG. 2 is a diagram illustrating coordinates of a cursor on a display according to exemplary embodiments;

FIG. 3 is a block diagram illustrating a remote pointing apparatus according to exemplary embodiments;

FIG. 4 is a diagram illustrating pulse trains of emitted lights according to exemplary embodiments;

FIG. 5 is a diagram illustrating waveforms when receiving the emitted lights of FIG. 4;

FIG. 6 is a diagram illustrating sawtooth waveforms of emitted lights according to exemplary embodiments;

FIG. 7 is a diagram illustrating waveforms when receiving the emitted lights of FIG. 6;

FIG. 8 is a diagram illustrating emitted ramp signal lights according to exemplary embodiments;

FIG. 9 is a diagram illustrating waveforms when receiving the emitted lights of FIG. 8;

FIG. 10 is a diagram illustrating emitted frequency-modulated lights according to exemplary embodiments;

FIG. 11 is a diagram illustrating waveforms when receiving the emitted lights of FIG. 10; and

FIG. 12 is a flowchart illustrating a remote pointing method according to exemplary embodiments.

### DETAILED DESCRIPTION

Reference will now be made in detail to exemplary embodiments, examples of which are illustrated in the accompanying drawings, wherein like reference numerals refer to the like elements throughout. Exemplary embodiments are described below to explain the present disclosure by referring to the figures.

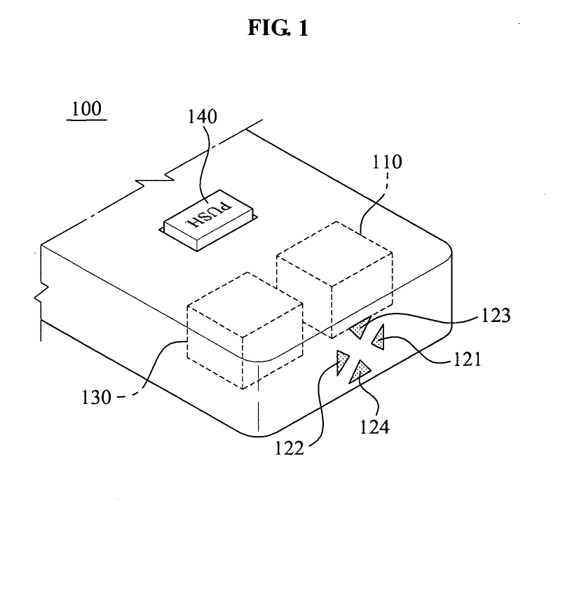

FIG. 1 is a diagram illustrating an apparatus 100 for transmitting an emitted light according to exemplary embodiments.

A control unit 110 may control a first light emitting unit 121, a second light emitting unit 122, a third light emitting unit 123, and a fourth light emitting unit 124 to emit a first emitted light, a second emitted light, a third emitted light, and a fourth emitted light. When an operation command is transmitted by a user, the control unit 110 may control the first light emitting unit 121, the second light emitting unit 122, the third light emitting unit 123, and the fourth light emitting unit 124 according to a predetermined scheme.

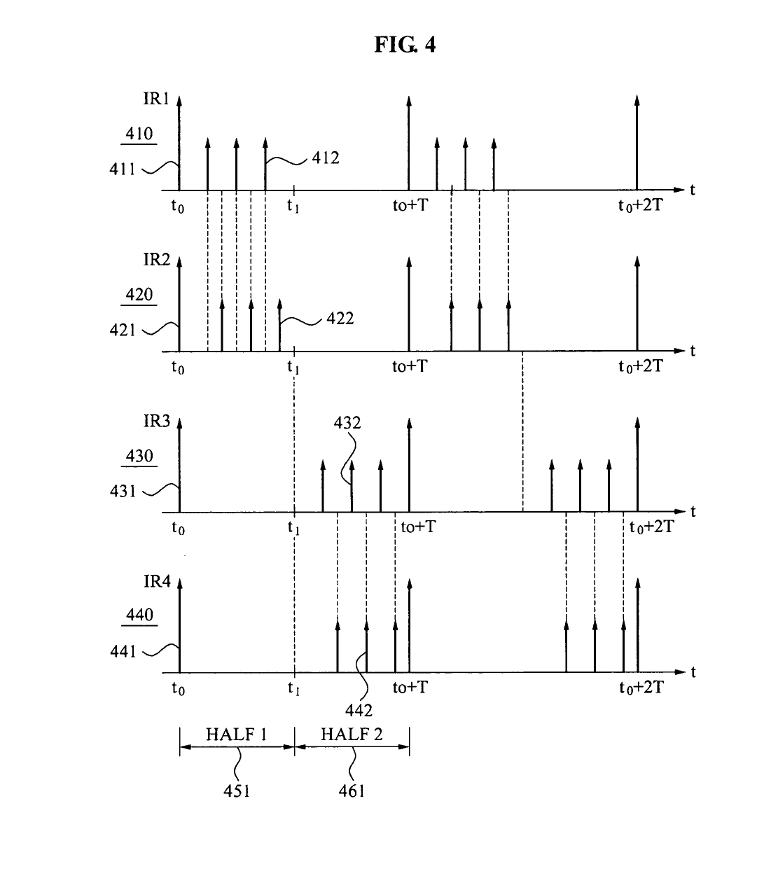

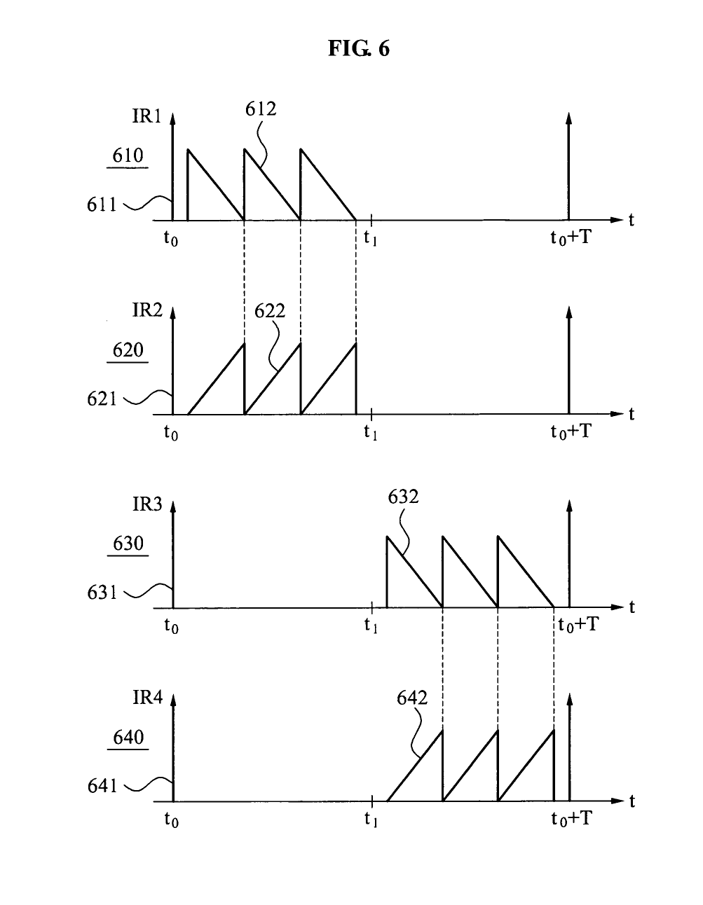

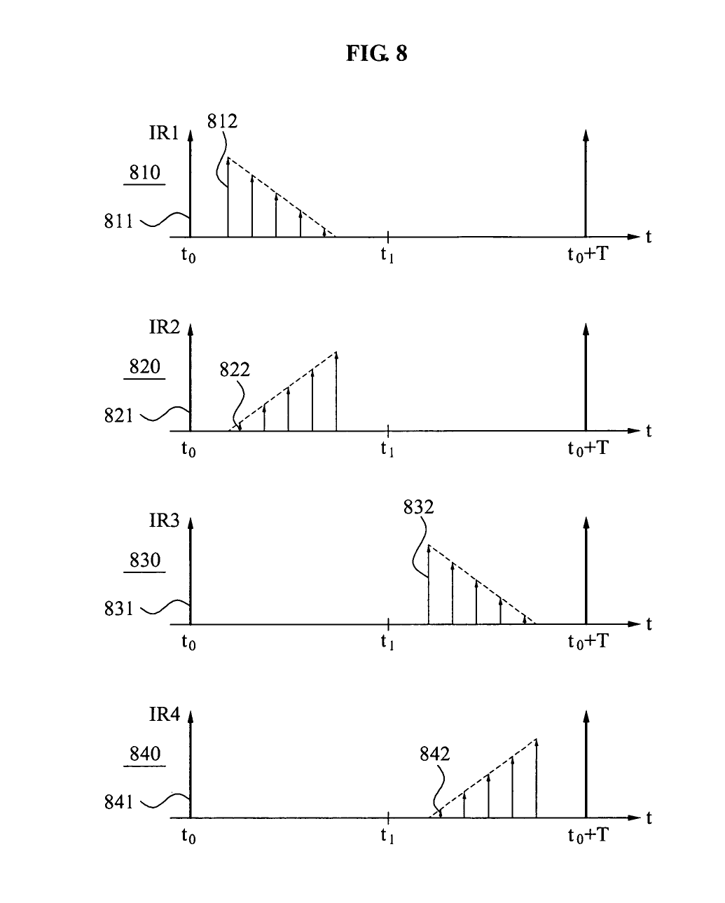

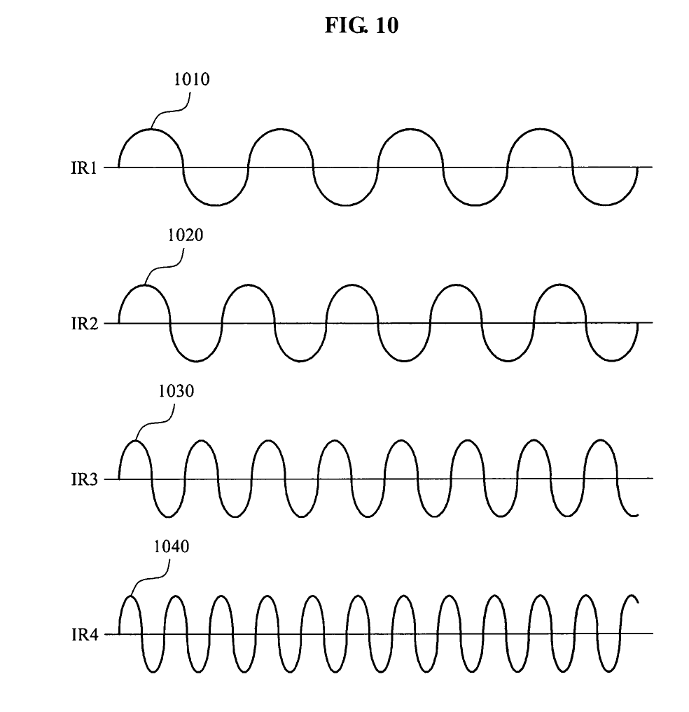

Waveforms of emitted lights emitted under control of the control unit 110 are described in detail with reference to FIG. 4, FIG. 6, FIG. 8, and FIG. 10.

At least one of the first light emitting unit 121, the second light emitting unit 122, the third light emitting unit 123, and the fourth light emitting unit 124 may be an infrared-ray light-emitting diode (IR LED).

The first light emitting unit 121 may emit the first emitted light towards a right side by a predetermined angle in a front side of the apparatus 100 for transmitting an emitted light (hereinafter, the apparatus 100). Accordingly, when the apparatus 100 faces a receiving unit, the first emitted light may be emitted to a right side of the receiving unit. Also, as the apparatus 100 faces left, the first emitted light may be emitted to the receiving unit more strongly.

The second light emitting unit 122 may emit the second emitted light towards a left side by a predetermined angle in the front side of the apparatus 100. Accordingly, when the apparatus 100 faces the receiving unit, the second emitted light may be emitted to a left side of the receiving unit. Also, as the apparatus 100 faces right, the second emitted light may be emitted to the receiving unit more strongly.

The third light emitting unit 123 may emit the third emitted light downwards by a predetermined angle in the front side of the apparatus 100. Accordingly, when the apparatus 100 faces the receiving unit, the third emitted light may be emitted to a lower part of the receiving unit. Also, as the apparatus 100 faces upwards, the third emitted light may be emitted to the receiving unit more strongly.

The fourth light emitting unit 124 may emit the third emitted light upwards by a predetermined angle in the front side of the apparatus 100. Accordingly, when the apparatus 100 faces the receiving unit, the fourth emitted light may be emitted to an upper part of the receiving unit. Also, as the apparatus 100 faces downwards, the fourth emitted light may be emitted to the receiving unit more strongly.

According to other exemplary embodiments, the second light emitting unit 122 may simultaneously function as any one of the third light emitting unit 123 and the fourth light emitting unit 124. In this instance, when the apparatus 100 faces the receiving unit, the second light emitted light may be emitted to the front side of the receiving unit. Hereinafter, although the first light emitting unit 121, the second light emitting unit 122, the third light emitting unit 123, and the fourth light emitting unit 124 are described, a light emitting unit may not be limited to the exemplary embodiments. According to still other exemplary embodiments, the second light emitting unit 122 may emit the second emitted light during a first half cycle, and the third emitted light during a second half cycle, and thus the third light emitting unit 123 may be omitted.

According to exemplary embodiment, a modulator 130 may modulate the first emitted light, the second emitted light, the third emitted light, and the fourth emitted light to a first frequency, a second frequency, a third frequency, and a fourth frequency. The modulator 130 may include an oscillator. However, amplitudes of the first emitted light modulated to the first frequency, and the second emitted light modulated to the second frequency, may be identical. The modulator 130 and the control unit 110 may adjust the amplitudes. The third emitted light modulated to the third frequency, and the fourth emitted light, modulated to the fourth frequency, may have a same amplitude.

The operation order of the user may be transmitted through a button 140 according to exemplary embodiments. The apparatus 100 may be activated and operated while the user pushes the button 140.

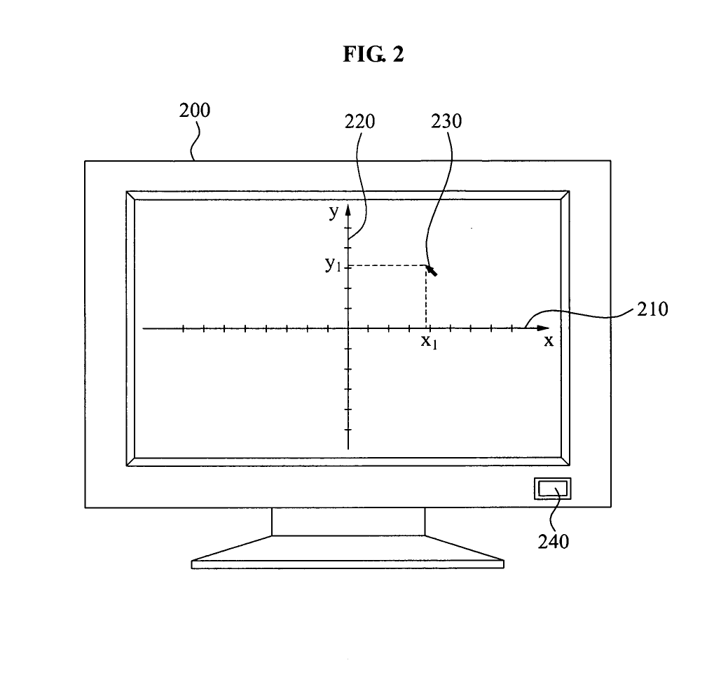

FIG. 2 is a diagram illustrating coordinates of a cursor on a display according to exemplary embodiments.

A cursor 230 may be on a display 200 such as a television (TV), Plasma Display Panel (PDP), Liquid Crystal Display (LCD) panel, and the like. Although the cursor 230 is illustrated as FIG. 2, any form which may indicate a particular point on a screen may be the cursor 230.

The cursor 230 may be used for a user to click a particular point on the display 200. Coordinates of the cursor 230 may be (x1, y1). Here, x1 may be a value of a first coordinate axis 210, hereinafter, x axis, and y1 may be a value of a second coordinate axis 220, hereinafter, y axis.

According to exemplary embodiments, a user may indicate the coordinates of the cursor 230, (x1, y1), on the display 200 through a remote control.

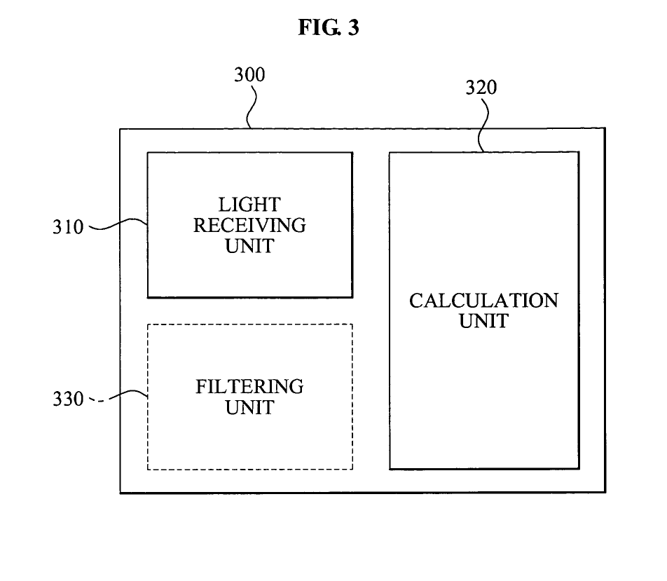

A light receiving unit 240 may receive a signal such as an IR signal, transmitted from the remote control. The light receiving unit 240 is described in detail with reference to FIG. 3.

FIG. 3 is a block diagram illustrating a remote pointing apparatus 300 according to exemplary embodiments.

According to exemplary embodiments, the remote pointing apparatus 300 may be embodied as a circuit module included in a circuit of the display 200 of FIG. 2.

A light receiving unit 310 may correspond to the light receiving unit 240 of FIG. 2.

The light receiving unit 310 may receive a first emitted light, a second emitted light, a third emitted light, and a fourth emitted light. Each of the first emitted light, the second emitted light, the third emitted light, and the fourth emitted light may be emitted in the first light emitting unit 121, the second light emitting unit 122, the third light emitting unit 123, and the fourth light emitting unit 124 of FIG. 1.

According to exemplary embodiments, the first emitted light and the second emitted light may be received during a first half cycle, and the third emitted light and the fourth emitted light may be received during a second half cycle. Also, a control signal may be received when receiving the first emitted light, the second emitted light, the third emitted light, and the fourth emitted light, which are periodic waves. In this instance, a waveform of each of the four emitted lights is described in detail with reference to FIG. 4, FIG. 6, and FIG. 8.

According to other exemplary embodiments, a first emitted light, a second emitted light, a third emitted light, and a fourth emitted light, modulated to different frequencies, may be simultaneously received. In this instance, a waveform of each of the four emitted lights is described in detail with reference to FIG. 10.

The light receiving unit 310 may be an IR sensor. However, the light receiving unit 310 may not be limited to the exemplary embodiment. Also, changes may be made with respect to the light receiving unit 310 depending on a type of signal emitted in a light emitting unit.

According to exemplary embodiments, a filtering unit 330 may analyze an amplitude for each frequency with respect to the first emitted light, the second emitted light, the third emitted light, and the fourth emitted light, when each of the four emitted lights is modulated to a first frequency, a second frequency, a third frequency, and a fourth frequency, and simultaneously emitted.

The filtering unit 330 may perform a band-pass filtering (BPF) with respect to the first emitted light received in the light receiving unit 310, using the first frequency as a center frequency. Also, the filtering unit 330 may provide the filtered light to the calculation unit 320. Also, the filtering unit 330 may filter the second emitted light according to the second frequency, the third emitted light according to the third frequency, and the fourth emitted light according to the fourth frequency. Here, the second emitted light, the third emitted light, and the fourth emitted light may be received in the light receiving unit 310.

The BPF may be performed in parallel or sequentially. A quad configuration may be used to simultaneously filter the four frequencies. Four filters may be utilized in parallel, in the quad configuration. Those skilled in the art may change a configuration of filters without departing from the principles and spirit of the disclosure.

The calculation unit 320 may calculate a first coordinate axis value and a second coordinate axis value of a cursor on a display. The first coordinate axis value and the second coordinate axis value have been described in detail with reference to FIG. 2.

According to exemplary embodiments, when the first emitted light and the second emitted light are received during the first half cycle, the calculation unit 320 may calculate the first coordinate axis value, that is, an x coordinate value of the cursor. Also, when the third emitted light and the fourth emitted light are received during a second half cycle, the calculation unit 320 may calculate the second coordinate axis value, that is, a y coordinate value of the cursor.

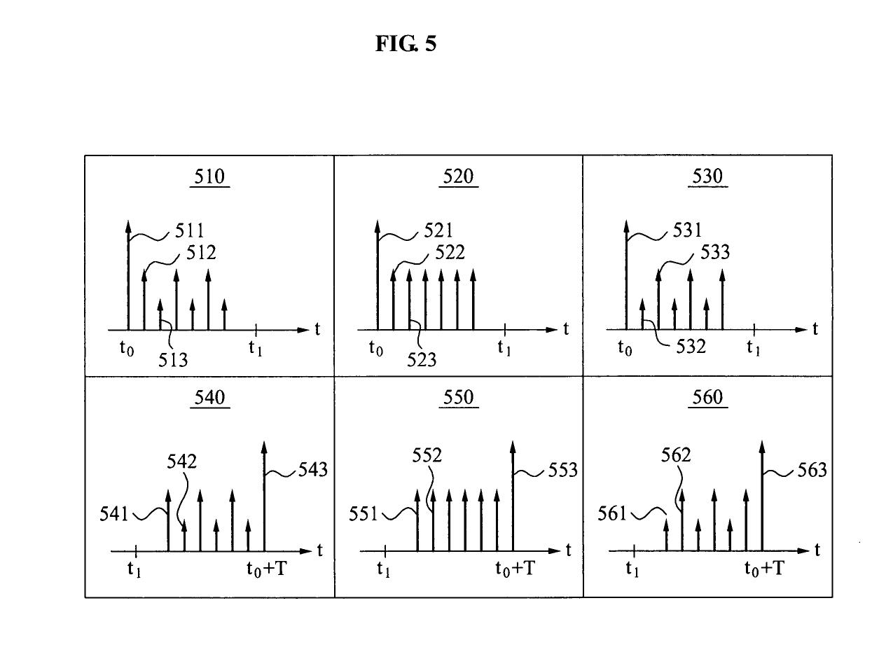

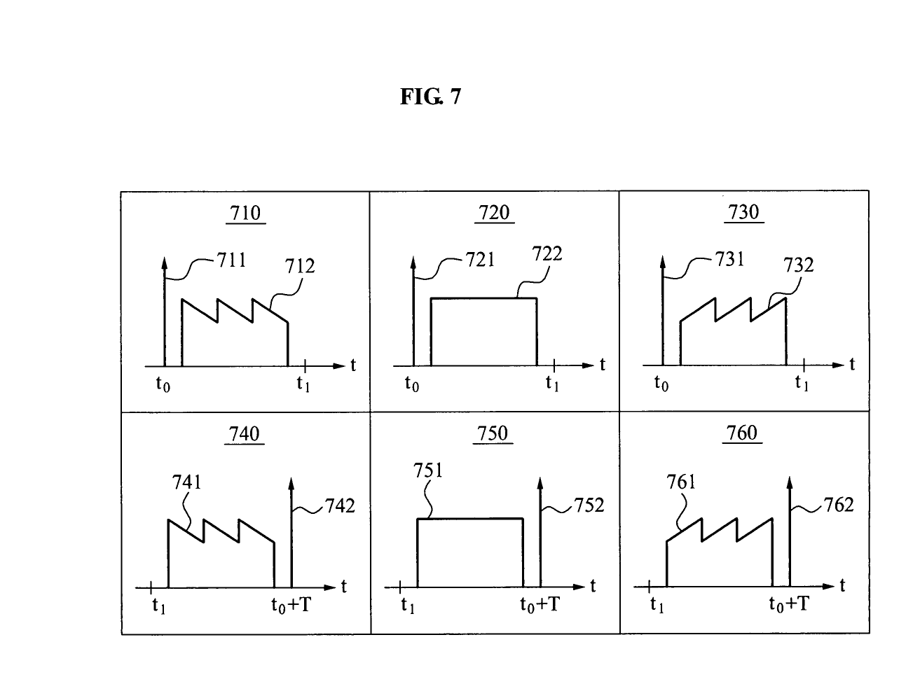

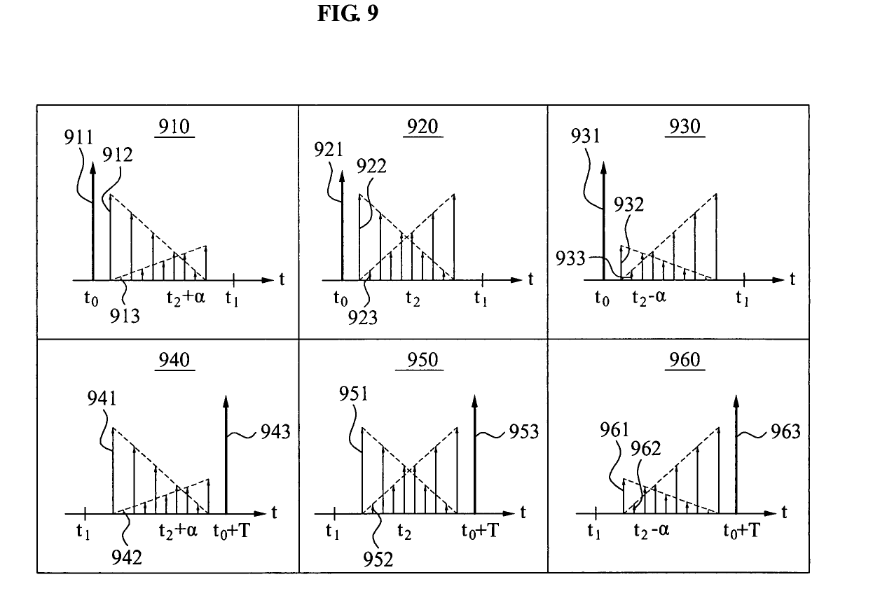

In this instance, an operation of calculating the x coordinate value of the cursor based on amplitudes of the received emitted lights is described in detail with reference to FIG. 5, FIG. 7, and FIG. 9.

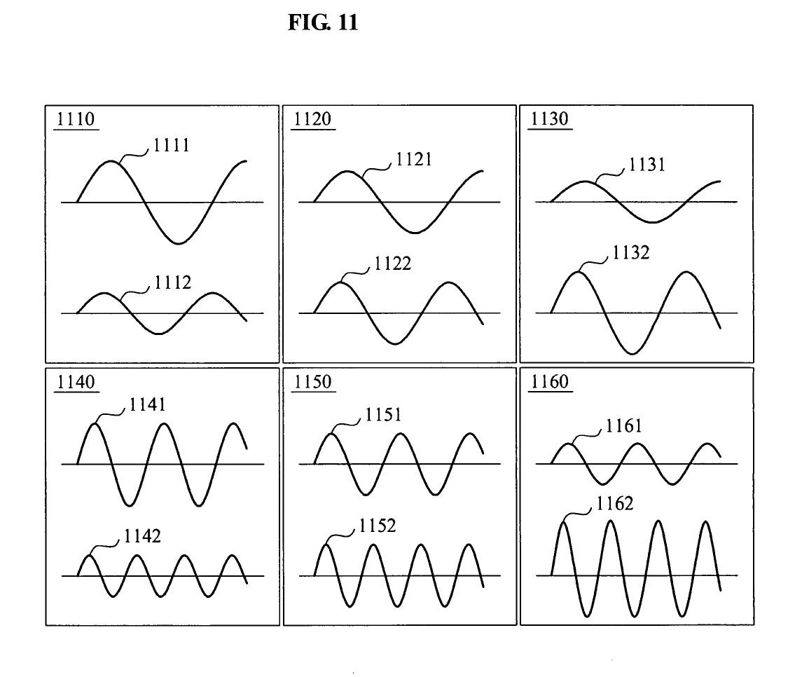

According to other exemplary embodiments, when the four emitted lights are simultaneously emitted and received, the calculation unit 320 may simultaneously calculate the first coordinate axis value and the second coordinate axis value of the cursor. An operation of calculating the first coordinate axis value and the second coordinate axis value based on amplitudes of the received emitted lights is described in detail with reference to FIG. 11.

FIG. 4 is a diagram illustrating pulse trains of emitted lights according to exemplary embodiments.

According to exemplary embodiments, a signal illustrated in a graph 410 may be a first emitted light 412 emitted by the first light emitting unit 121 of FIG. 1. The first emitted light 412 may include a plurality of pulses and have a cycle T. Also, the first emitted light 412 may be emitted during a first half cycle 451.

The first half cycle 451 may be a partial time period of the cycle T of the first emitted light 412. The first half cycle 451 may be a period t (t0+k*T<t<t1+k*T). Here, k may be a positive number. Also, a second half cycle 461 may be a remaining time period of the cycle T. The second half cycle 461 may be another period t (t1+k*T<t< to +(k+1)T). Here, k may be a positive number. Hereinafter, the first half cycle 451 and the second half cycle 461 may be the same with respect to other emitted lights in FIG. 4 through FIG. 12.

Although ‘first half cycle’ and ‘second half cycle’ are used for convenience of description, the cycle may not be limited to the exemplary embodiments. Accordingly, a time length of the first half cycle and the second half cycle are not required to be identical, and the time length may vary.

According to exemplary embodiments, a signal illustrated in a graph 420 may be a second emitted light 422 emitted by the second light emitting unit 122. The second emitted light 422 may include a plurality of pulses and have the cycle T. Also, the second emitted light 422 may be emitted during the first half cycle 451.

According to exemplary embodiments, a signal illustrated in a graph 430 may be a third emitted light 432 emitted by the third light emitting unit 123. The third emitted light 432 may include a plurality of pulses and have the cycle T. Also, the third emitted light 432 may be emitted during the second half cycle 461.

According to exemplary embodiments, a signal illustrated in a graph 440 may be a fourth emitted light 442 emitted by the fourth light emitting unit 124. The fourth emitted light 442 may include a plurality of pulses and have the cycle T. Also, the fourth emitted light 442 may be emitted during the second half cycle 461.

According to exemplary embodiments, the first light emitting unit 121, the second light emitting unit 122, the third light emitting unit 123, and the fourth light emitting unit 124 may emit each control signal 411, 421, 431, and 441 to distinguish the first half cycle 451 from the second half cycle 461. Each of the control signals 411, 421, 431, and 441 may be a periodic signal having the cycle T.

An amplitude of the first emitted light 412 is identical to an amplitude of the second emitted light 422. Also, the first emitted light 412 and the second emitted light 422 have a first phase difference. According to exemplary embodiments, as illustrated in the graphs 410 and 420, the first phase difference may be 180 degrees. However, the phase difference may not be limited to the exemplary embodiments, and be an arbitrary phase difference which prevents the first emitted light 412 and the second emitted light 422 from overlapping.

Also, an amplitude of the third emitted light 432 is identical to an amplitude of the fourth emitted light 442. Also, the third emitted light 432 and the fourth emitted light 442 have a second phase difference. As illustrated in the graphs 430 and 440, the second phase difference may be 180 degrees. According to other exemplary embodiments, however, the second phase difference may be an arbitrary phase difference which prevents the third emitted light 432 and the fourth emitted light 442 from overlapping. The first phase difference may be identical to the second phase difference.

FIG. 5 is a diagram illustrating waveforms when receiving the emitted lights of FIG. 4.

A graph 510 may illustrate emitted lights received during a first half cycle. Specifically, the emitted lights, that are received for a predetermined time (t1−t0) after a control signal 511 is received, may be received during the first half cycle. Also, a light emitting unit emitting the emitted lights during the first half cycle may be the first light emitting unit 121 and the second light emitting unit 122.

A received first emitted light 512 and second emitted light 513 may be used for calculating an x coordinate value, that is, a first coordinate axis value, of the cursor 230 of FIG. 2. An amplitude of the first emitted light 512 may be greater than an amplitude of the second emitted light 513 in the graph 510. Although the first light emitting unit 121 and the second light emitting unit 122 emit emitted lights having a same amplitude, it may be sensed by the light receiving unit 240 that the amplitude of the first emitted light 512 is greater than the amplitude of the second emitted light 513. Accordingly, it may be determined that a remote control 100, that is, the apparatus 100, that transmits emitted lights is towards a left side as opposed to a center. Accordingly, the x coordinate value of the cursor 230 may be a negative number, and be in proportion to a difference between the received first emitted light 512 and the second emitted light 513.

A graph 520 may illustrate emitted lights received during the first half cycle. Specifically, the emitted lights, that are received for the predetermined time (t1−t0) after a control signal 521 is received, may be received during the first half cycle.

A received first emitted light 522 and a second emitted light 523 may be used for calculating the x coordinate value, that is, the first coordinate axis value, of the cursor 230. An amplitude of the first emitted light 522 may be the same as an amplitude of the second emitted light 523 in the graph 520. Accordingly, it may not be determined that the remote control 100 that transmits emitted lights is towards the left or right. Accordingly, the x coordinate value of the cursor 230 may be 0.

A graph 530 may illustrate emitted lights received during the first half cycle. Specifically, the emitted lights, that are received for the predetermined time (t1−t0) after a control signal 531 is received, may be received during the first half cycle. An amplitude of a first emitted light 532 may be less than an amplitude of a second emitted light 533 in the graph 530. Accordingly, it may be determined that the remote control 100 that transmits emitted lights is towards the right. Accordingly, the x coordinate value of the cursor 230 may be a positive number, and be in proportion to a difference between the received first emitted light 532 and the second emitted light 533.

A graph 540 may illustrate emitted lights received during a second half cycle. Specifically, the emitted lights, that are received for a predetermined time (t0+T−t1) before a control signal 543 is received, may be received during the second half cycle. Also, a light emitting unit emitting the emitted lights during the second half cycle may be the third light emitting unit 123 and the fourth light emitting unit 124.

A received third emitted light 541 and a fourth emitted light 542 may be used for calculating a y coordinate value, that is, a second coordinate axis value, of the cursor 230 of FIG. 2. An amplitude of the third emitted light 541 may be greater than an amplitude of the fourth emitted light 542 in the graph 540. Although the third light emitting unit 123 and the fourth light emitting unit 124 emit emitted lights having a same amplitude, it may be sensed by the light receiving unit 240 that the amplitude of the third emitted light 541 is greater than the amplitude of the fourth emitted light 542. Accordingly, it may be determined that the remote control 100 that transmits emitted lights is towards an upper part. Accordingly, the y coordinate value of the cursor 230 may be a positive number, and be in proportion to a difference between the received third emitted light 541 and fourth emitted light 542.

A graph 550 may illustrate emitted lights received during the second half cycle. Specifically, the emitted lights, that are received for the predetermined time (t0+T−t1) before a control signal 553 is received, may be received during the second half cycle.

A received third emitted light 551 and fourth emitted light 552 may be used for calculating the y coordinate value, that is, second coordinate axis value, of the cursor 230. An amplitude of the third emitted light 551 may be the same as an amplitude of fourth emitted light 552 in the graph 550. Accordingly, it may not be determined that the remote control 100 that transmits emitted lights is towards an upper or lower part. Accordingly, the y coordinate value of the cursor 230 may be 0.

A graph 560 may illustrate emitted lights received during the second half cycle. Specifically, the emitted lights, that are received for a predetermined time (t0+T−t1) before a control signal 563 is received, may be received during the second half cycle. An amplitude of a third emitted light 561 may be less than an amplitude of a fourth emitted light 562 in the graph 560. Accordingly, it may be determined that the remote control 100 that transmits emitted lights is towards a lower part. Accordingly, the y coordinate value of the cursor 230 may be a negative number, and be in proportion to a difference between the received third emitted light 561 and fourth emitted light 562.

FIG. 6 is a diagram illustrating sawtooth waveforms of emitted lights, which are continuous signals, according to exemplary embodiments.

According to exemplary embodiments, a signal illustrated in a graph 610 may be a first emitted light 612 emitted by the first light emitting unit 121 of FIG. 1. The first emitted light 612 may be a signal of a downward ramp sawtooth waveform, and a continuous signal. The first emitted light 612 may have a cycle T, and be emitted during a first half cycle.

According to exemplary embodiments, a signal illustrated in a graph 620 may be a second emitted light 622 emitted by the second light emitting unit 122 of FIG. 1. The second emitted light 622 may be a signal of an upward ramp sawtooth waveform, and a continuous signal. The second emitted light 622 may have the cycle T, and be emitted during the first half cycle.

According to exemplary embodiments, a signal illustrated in a graph 630 may be a third emitted light 632 emitted by the third light emitting unit 123 of FIG. 1. The third emitted light 632 may be a signal of a downward ramp sawtooth waveform, and a continuous signal. The third emitted light 632 may have the cycle T, and be emitted during a second half cycle.

According to exemplary embodiments, a signal illustrated in a graph 640 may be a fourth emitted light 642 emitted by the fourth light emitting unit 124 of FIG. 1. The fourth emitted light 642 may be a signal of an upward ramp sawtooth waveform, and a continuous signal. The fourth emitted light 642 may have the cycle T, and be emitted during the second half cycle.

According to exemplary embodiments, the first light emitting unit 121, the second light emitting unit 122, the third light emitting unit 123, and the fourth light emitting unit 124 may emit each control signal 611, 621, 631, and 641 to distinguish the first half cycle from the second half cycle. Each of the control signals 611, 621, 631, and 641 may be a periodic signal having the cycle T.

The first emitted light 612 and the second emitted light 622 may have a same maximum amplitude. The third emitted light 632 and the fourth emitted light 642 may have a same maximum amplitude.

FIG. 7 is a diagram illustrating waveforms when receiving the emitted lights of FIG. 6.

A graph 710 may illustrate an emitted light received during a first half cycle. Specifically, the emitted light, that is received for a predetermined time (t1−t0) after a control signal 711 is received, may be received during the first half cycle. Also, a light emitting unit emitting the emitted light during the first half cycle may be the first light emitting unit 121 and the second light emitting unit 122.

A received emitted light 712 is used for calculating an x coordinate value, that is, a first coordinate axis value, of the cursor 230 of FIG. 2. An amplitude of the emitted light 712 may show a ramp-down characteristic in the graph 710. Although the first light emitting unit 121 and the second light emitting unit 122 emit emitted lights of the downward ramp sawtooth waveform and the upward ramp sawtooth waveform, the ramp-down characteristic may be sensed by the light receiving unit 240. In this instance, the emitted lights of the downward ramp sawtooth waveform and the upward ramp sawtooth waveform may have a same maximum amplitude. Accordingly, it may be determined that a remote control 100 that transmits emitted lights is towards a left side. Accordingly, the x coordinate value of the cursor 230 may be a negative number, and be in proportion to a difference between a maximum amplitude and a minimum amplitude of the received emitted light 712.

A graph 720 may illustrate an emitted light received during the first half cycle. Specifically, the emitted light, that is received for the predetermined time (t1−t1) after a control signal 721 is received, may be received during the first half cycle.

A received emitted light 722 is used for calculating the x coordinate value, that is, the first coordinate axis value, of the cursor 230. The received emitted light 722 may show a characteristic of a constant amplitude in the graph 720. Accordingly, it may not be determined that the remote control 100 that transmits emitted lights is towards the left or right. Accordingly, the x coordinate value of the cursor 230 may be 0.

A graph 730 may illustrate an emitted light received during the first half cycle. Specifically, the, emitted light, that is received for the predetermined time (t1−t0) after a control signal 731 is received, may be received during the first half cycle. An amplitude of a received emitted light 732 may show a ramp-up characteristic in the graph 730. Accordingly, it may be determined that the remote control 100 that transmits emitted lights is towards the right. Accordingly, the x coordinate value of the cursor 230 may be a positive number, and be in proportion to a difference between a maximum amplitude and a minimum amplitude of the received emitted light 732.

A graph 740 may illustrate an emitted light received during a second half cycle. Specifically, the emitted light, that is received for a predetermined time (t0+T−t1) before a control signal 742 is received, may be received during the second half cycle. Also, a light emitting unit emitting the emitted lights during the second half cycle may be the third light emitting unit 123 and the fourth light emitting unit 124.

A received emitted light 741 is used for calculating a y coordinate value, that is, a second coordinate axis value, of the cursor 230. An amplitude of the emitted light 741 may show a ramp-down characteristic in the graph 740. Although the third light emitting unit 123 and the fourth light emitting unit 124 emit emitted lights having a same amplitude, the ramp-down characteristic may be sensed by the light receiving unit 240. Accordingly, it may be determined that the remote control 100 that transmits emitted lights is towards an upper part. Accordingly, the y coordinate value of the cursor 230 may be a positive number, and be in proportion to a difference between a maximum amplitude and a minimum amplitude of the emitted light 742.

A graph 750 may illustrate an emitted light received during the second half cycle. Specifically, the emitted light, that is received for the predetermined time (t0+T−t1) before the control signal 752 is received, may be received during the second half cycle.

A received emitted light 751 may show a constant amplitude characteristic in the graph 750. Accordingly, it may not be determined that the remote control 100 that transmits emitted lights is towards the upper or the lower part. Accordingly, the y coordinate value of the cursor 230 may be 0.

A graph 760 may illustrate an emitted light received during the second half cycle. Specifically, the emitted light, that is received for the predetermined time (t0+T−t1) before a control signal 762 is received, may be received during the second half cycle. An amplitude of a received emitted light 761 may show a ramp-up characteristic in the graph 760. Accordingly, it may be determined that the remote control 100 that transmits emitted lights is towards a lower part. Accordingly, the y coordinate value of the cursor 230 may be a negative number, and be in proportion to a difference between a maximum amplitude and a minimum amplitude of the emitted light 761.

FIG. 8 is a diagram illustrating emitted ramp signal lights according to exemplary embodiments.

According to exemplary embodiments, a signal illustrated in a graph 810 may be a first emitted light 812 emitted by the first light emitting unit 121 of FIG. 1. The first emitted light 812 may be a downward ramp pulse train signal having a ramp-down characteristic. The first emitted light 812 may have a cycle T, and be emitted during a first half cycle.

According to exemplary embodiments, a signal illustrated in a graph 820 may be a second emitted light 822 emitted by the second light emitting unit 122 of FIG. 1. The second emitted light 822 may be an upward ramp pulse train signal having a ramp-up characteristic. The second emitted light 822 may have the cycle T, and be emitted during the first half cycle.

According to exemplary embodiments, a signal illustrated in a graph 830 may be a third emitted light 832 emitted by the third light emitting unit 123 of FIG. 1. The third emitted light 832 may be a downward ramp pulse train signal having a ramp-down characteristic. The third emitted light 832 may have the cycle T, and be emitted during a second half cycle.

According to exemplary embodiments, a signal illustrated in a graph 840 may be a fourth emitted light 842 emitted by the fourth light emitting unit 124 of FIG. 1. The fourth emitted light 842 may be an upward ramp pulse train signal having a ramp-up characteristic. The fourth emitted light 842 may have the cycle T, and be emitted during the second half cycle.

According to exemplary embodiments, the first light emitting unit 121, the second light emitting unit 122, the third light emitting unit 123, and the fourth light emitting unit 124 may emit each control signal 811, 821, 831, and 841 to distinguish the first half cycle from the second half cycle. Each of the control signals 811, 821, 831, and 841 may be a periodic signal having the cycle T.

The first emitted light 812 and the second emitted light 822 may have a same maximum amplitude. The third emitted light 832 and the fourth emitted light 842 may have a same maximum amplitude.

According to exemplary embodiments, the first emitted light 812 may be a pulse train showing the ramp-down characteristic at least twice during the first half cycle. In this instance, the second emitted light 822 may be a pulse train showing the ramp-up characteristic a same number of times as the number of times that the ramp-down characteristic shows in the first emitted light 812. Similarly, the third emitted light 832 may be a pulse train showing the ramp-down characteristic at least twice during the first half cycle. In this instance, the fourth emitted light 842 may be a pulse train showing the ramp-up characteristic a same number of times as the number of times that the ramp-down characteristic shows in the third emitted light 832.

For example, each of the first emitted light 812 and the third emitted light 832 may ramp downward three times, and each of the second emitted light 822 and the fourth emitted light 842 may ramp upwards three times. In this instance, each of the first emitted light 812, the second emitted light 822, the third emitted light 832, and the fourth emitted light 842 may be a pulse train signal converted from the first emitted light 612, the second emitted light 622, the third emitted light 632, and the fourth emitted light 642 of FIG. 6. Here, each of the first emitted light 812, the second emitted light 822, the third emitted light 832, and the fourth emitted light 842 may be a continuous signal, and the pulse train signal may be a discrete signal.

FIG. 9 is a diagram illustrating waveforms when receiving the emitted lights of FIG. 8.

According to exemplary embodiments, the light receiving unit 310 of FIG. 3 may receive the first emitted light 812 and the second emitted light 822 during the first half cycle, and compare amplitudes of the first emitted light 812 and the second emitted light 822. Also, the light receiving unit 310 may receive the third emitted light 832 and the fourth emitted light 842 during the second half cycle, and compare amplitudes of the third emitted light 832 and the fourth emitted light 842.

A graph 910 may illustrate emitted lights received during a first half cycle. Specifically, the emitted lights, that are received for a predetermined time (t1−t0) after a control signal 911 is received, may be received during the first half cycle. Also, a light emitting unit emitting the emitted light during the first half cycle may be the first light emitting unit 121 and the second light emitting unit 122.

A received first emitted light 912 and second emitted light 913 may be used for calculating an x coordinate value, that is, a first coordinate axis value, of the cursor 230 of FIG. 2. An amplitude of the first emitted light 912 and an amplitude of the second emitted light 913 may be identical at t2+α in the graph 910. Although the first light emitting unit 121 and the second light emitting unit 122 emit the emitted lights having a same maximum amplitude, it may be sensed by the light receiving unit 240 that a time that the amplitude of the first emitted light 912 is identical to the amplitude of the second emitted light 913 is close to t1. Here, the emitted lights having the same maximum amplitude may be signals of a ramp downward pulse train and a ramp upward pulse train. Accordingly, it may be determined that a remote control 100 that transmits emitted lights is towards the left. Thus, the x coordinate value of the cursor 230 may be a negative number, and be in proportion to a indicating how close the time and t1 are.

A graph 920 may illustrate emitted lights received during the first half cycle. Specifically, the emitted lights, that are received for the predetermined time (t1−t0) after a control signal 921 is received, may be received during the first half cycle.

A received first emitted light 922 and second emitted light 923 may be used for calculating the x coordinate value, that is, the first coordinate axis value, of the cursor 230. Since an amplitude of the first emitted light 922 and an amplitude of the second emitted light 923 may be identical at t2 in the graph 920, the first emitted light 922 and second emitted light 923 may be balanced. Accordingly, it may not be determined that the remote control 100 that transmits emitted lights is towards the left or right. Accordingly, the x coordinate value of the cursor 230 may be 0.

A graph 930 may illustrate emitted lights received during the first half cycle. Specifically, the emitted lights, that are received for the predetermined time (t1−t0) after a control signal 931 is received, may be received during the first half cycle. An amplitude of the first emitted light 932 and an amplitude of the second emitted light 933 may be identical at t2−α in the graph 930. Although the first light emitting unit 121 and the second light emitting unit 122 emit the emitted lights having a same maximum amplitude, it may be sensed by the light receiving unit 240 that a time that the amplitude of the first emitted light 932 is identical to the amplitude of the second emitted light 933 is close to t0. Here, the emitted lights having the same maximum amplitude may be signals of a ramp downward pulse train and a ramp upward pulse train. Accordingly, it may be determined that the remote control 100 that transmits emitted lights is towards the right. Thus, the x coordinate value of the cursor 230 may be a positive number, and be in proportion to α.

A graph 940 may illustrate emitted lights received during the second half cycle. Specifically, the emitted lights, that are received for a predetermined time (t0+T−t1) before a control signal 943 is received, may be received during the second half cycle. Also, a light emitting unit emitting the emitted lights during the second half cycle may be the third light emitting unit 123 and the fourth light emitting unit 124.

A received third emitted light 941 and fourth emitted light 942 may be used for calculating a y coordinate value, that is, a second coordinate axis value, of the cursor 230. An amplitude of the first emitted light 941 and an amplitude of the second emitted light 942 may be identical at t2+α in the graph 940. Although the third light emitting unit 123 and the fourth light emitting unit 124 emit the emitted lights having a same maximum amplitude, it may be sensed by the light receiving unit 240 that a time that the amplitude of the first emitted light 941 is identical to the amplitude of the second emitted light 942 is close to t0+T. Here, the emitted lights having the same maximum amplitude may be signals of a ramp downward pulse train and a ramp upward pulse train. Accordingly, it may be determined that the remote control 100 that transmits emitted lights is towards an upper part. Thus, the x coordinate value of the cursor 230 may be a positive number, and be in proportion to α.

A graph 950 may illustrate emitted lights received during the second half cycle. Specifically, the emitted lights, that are received for the predetermined time (t0+T−t1) before a control signal 953 is received, may be received during the second half cycle.

A received third emitted light 951 and a received fourth emitted light 952 may be used for calculating the y coordinate value, that is, second coordinate axis value, of the cursor 230. Since an amplitude of the first emitted light 951 and an amplitude of the second emitted light 952 may be identical at t2 in the graph 950, the first emitted light 951 and second emitted light 952 may be balanced. Accordingly, it may not be determined that the remote control 100 that transmits emitted lights is towards an upper or a lower part. Accordingly, the y coordinate value of the cursor 230 may be 0.

A graph 960 may illustrate emitted lights received during the second half cycle. Specifically, the emitted lights, that are received for a predetermined time (t0+T−t1) before a control signal 963 is received, may be received during the second half cycle. An amplitude of a first emitted light 961 and an amplitude of a second emitted light 962 may be identical at t2−α in the graph 960. Although the third light emitting unit 123 and the fourth light emitting unit 124 emit the emitted lights having a same maximum amplitude, it may be sensed by the light receiving unit 240 that a time that the amplitude of the first emitted light 961 is identical to the amplitude of the second emitted light 962 is close to t1. Here, the emitted lights having the same maximum amplitude may be signals of a ramp downward pulse train and a ramp upward pulse train. Accordingly, it may be determined that the remote control 100 that transmits emitted lights is towards a lower part. Thus, the y coordinate value of the cursor 230 may be a negative number, and be in proportion to α.

FIG. 10 is a diagram illustrating emitted frequency-modulated lights according to exemplary embodiments.

According to exemplary embodiments, a control signal is not required.

A first emitted light 1010 may be modulated to a first frequency and emitted by the first light emitting unit 121. A second emitted light 1020 may be modulated to a second frequency and emitted by the second light emitting unit 122. A third emitted light 1030 may be modulated to a third frequency and emitted by the third light emitting unit 123, and a fourth emitted light 1040 may be modulated to a fourth frequency and emitted by the fourth light emitting unit 124.

According to exemplary embodiments, an amplitude of the first emitted light 1010 is identical to an amplitude of the second emitted light 1020. Also, an amplitude of the third emitted light 1030 is identical to an amplitude of the fourth emitted light 1040.

FIG. 11 is a diagram illustrating waveforms when receiving the emitted lights of FIG. 10.

The light receiving unit 310 may receive waves where the first emitted light 1010, the second emitted light 1020, the third emitted light 1030, and the fourth emitted light 1040 overlap. Also, the filtering unit 330 may filter the received first emitted light 1010, the received second emitted light 1020, the received third emitted light 1030, and the received fourth emitted light 1040 to a first frequency component, a second frequency component, a third frequency component, and a fourth frequency component;

The calculation unit 320 may compare amplitudes of the first frequency component and the second frequency component, and calculate an x coordinate value, that is, a first coordinate axis value, of the cursor 230. Also, the calculation unit 320 may compare amplitudes of the third frequency component and the fourth frequency component, and calculate a y coordinate value, that is, a second coordinate axis value, of the cursor 230. Since the calculating of the x coordinate value and the y coordinate value may be simultaneously performed, calculation may be quickly performed.

A graph 1110 may illustrate a filtered first frequency component 1111 and second frequency component 1112. The first frequency component 1111 and second frequency component 1112 may be used for calculating the x coordinate value, that is, the first coordinate axis value, of the cursor 230. An amplitude of the first frequency component 1111 may be greater than an amplitude of the second frequency component 1112 in the graph 1110. Although the first light emitting unit 121 and the second light emitting unit 122 emit emitted lights having a same amplitude, it may be sensed by the light receiving unit 240 that the amplitude of the first frequency component 1111 is greater than the amplitude of the second frequency component 1112. Accordingly, it may be determined that a remote control 100 that transmits emitted lights is towards the left. Accordingly, the x coordinate value of the cursor 230 may be a negative number, and may be in proportion to a difference between the amplitudes of the first frequency component 1111 and the second frequency component 1112.

A graph 1120 may illustrate a filtered first frequency component 1121 and second frequency component 1122. The first frequency component 1121 and second frequency component 1122 may be used for calculating the x coordinate value, that is, the first coordinate axis value, of the cursor 230. An amplitude of the first frequency component 1121 may be identical to an amplitude of the second frequency component 1122 in the graph 1120. Accordingly, it may not be determined that the remote control 100 that transmits emitted lights is towards the left or right. Accordingly, the x coordinate value of the cursor 230 may be 0.

A graph 1130 may illustrate a filtered first frequency component 1131 and second frequency component 1132. The first frequency component 1131 and second frequency component 1132 may be used for calculating the x coordinate value, that is, the first coordinate axis value, of the cursor 230. An amplitude of the first frequency component 1131 may be less than an amplitude of the second frequency component 1132 in the graph 1130. Although the first light emitting unit 121 and the second light emitting unit 122 emit emitted lights having a same amplitude, it may be sensed by the light receiving unit 240 that the amplitude of the first frequency component 1131 is less than the amplitude of the second frequency component 1132. Accordingly, it may be determined that the remote control 100 that transmits emitted lights is towards the right. Accordingly, the x coordinate value of the cursor 230 may be a positive number, and be in proportion to a difference between the amplitudes of the first frequency component 1131 and the second frequency component 1132.

A graph 1140 may illustrate a filtered third frequency component 1141 and a filtered fourth frequency component 1142. The third frequency component 1141 and the fourth frequency component 1142 may be used for calculating the y coordinate value, that is, the second coordinate axis value, of the cursor 230. An amplitude of the third frequency component 1141 may be greater than an amplitude of the fourth frequency component 1142 in the graph 1140. Although the third light emitting unit 123 and the fourth light emitting unit 124 emit emitted lights having a same amplitude, it may be sensed by the light receiving unit 240 that the amplitude of the third frequency component 1141 is greater than the amplitude of the fourth frequency component 1142. Accordingly, it may be determined that the remote control 100 that transmits emitted lights is towards an upper part. Accordingly, the y coordinate value of the cursor 230 may be a positive number, and be in proportion to a difference between the amplitudes of the third frequency component 1141 and the fourth frequency component 1142.

A graph 1150 may illustrate a filtered third frequency component 1151 and a filtered fourth frequency component 1152. The third frequency component 1151 and the fourth frequency component 1152 may be used for calculating the y coordinate value, that is, the second coordinate axis value, of the cursor 230. An amplitude of the third frequency component 1151 may be identical to an amplitude of the fourth frequency component 1152 in the graph 1150. Accordingly, it may not be determined that the remote control 100 that transmits emitted lights faces upwards or downwards. Accordingly, the y coordinate value of the cursor 230 may be 0.

A graph 1160 may illustrate a filtered third frequency component 1161 and a filtered fourth frequency component 1162. The third frequency component 1161 and the fourth frequency component 1162 may be used for calculating the y coordinate value, that is, the second coordinate axis value, of the cursor 230. An amplitude of the third frequency component 1161 may be less than an amplitude of the fourth frequency component 1162 in the graph 1160. Although the third light emitting unit 123 and the fourth light emitting unit 124 emit emitted lights having a same amplitude, it may be sensed by the light receiving unit 240 that the amplitude of the third frequency component 1161 is less than the amplitude of the fourth frequency component 1162. Accordingly, it may be determined that the remote control 100 that transmits emitted lights is towards a lower part. Accordingly, the y coordinate value of the cursor 230 may be a negative number, and may be in proportion to a difference between the amplitudes of the third frequency component 1161 and the fourth frequency component 1162.

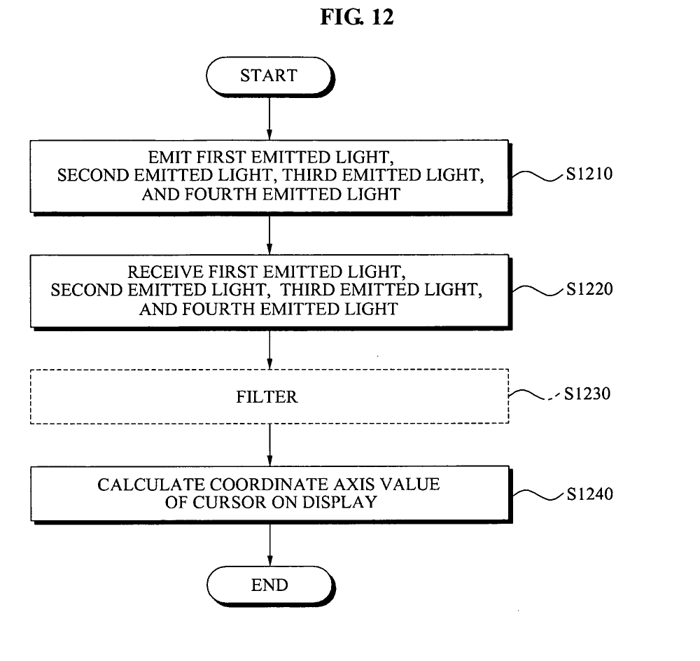

FIG. 12 is a flowchart illustrating a remote pointing method according to exemplary embodiments.

In operation S1210, a first emitted light, a second emitted light, a third emitted light, and a fourth emitted light may be emitted. Each of the first emitted light, the second emitted light, the third emitted light, and the fourth emitted light may be emitted in a first light emitting unit 121, a second light emitting unit 122, a third light emitting unit 123, and a fourth light emitting unit 124, respectively.

According to exemplary embodiments, the first emitted light and the second emitted light may be emitted during a first half cycle, and the third emitted light and the fourth emitted light may be emitted during a second half cycle. In this instance, a waveform of each of the four emitted lights is illustrated in FIGS. 4, 6, and 8. However, the waveform may not be limited to the exemplary embodiments. Specifically, as long as an x coordinate value, that is, a first coordinate axis value, of the cursor 230 may be determined by comparing amplitudes of the first emitted light and the second emitted light, and as long as a y coordinate value, that is, a second coordinate axis value, of the cursor 230 may be determined by comparing amplitudes of the third emitted light and the fourth emitted light, changes may be made with respect to the waveform of each of the four emitted lights.

Also, in operation S1210, the four emitted lights which are periodic waves may be emitted together with each control signal in the first light emitting unit 121, the second light emitting unit 122, the third light emitting unit 123, and the fourth light emitting unit 124.

According to other exemplary embodiments, the first emitted light, the second emitted light, the third emitted light, and the fourth emitted light may be modulated to a first frequency, a second frequency, a third frequency, and a fourth frequency, respectively, and simultaneously emitted. In this instance, the control signal is not required to be transmitted. Also, an amplitude of the first emitted light is required to be identical to an amplitude of the second emitted light, and an amplitude of the third emitted light is required to be identical to an amplitude of the fourth emitted light.

In operation S1220, the light receiving unit 310 may receive the first emitted light, the second emitted light, the third emitted light, and the fourth emitted light. According to exemplary embodiments, the light receiving unit 310 may be an IR sensor. However, the light receiving unit 310 may vary depending on a type of a signal transmitted in a light emitting unit.

In operation S1230, according to other exemplary embodiments, when the first emitted light, the second emitted light, the third emitted light, and the fourth emitted light are modulated to the first frequency, the second frequency, the third frequency, and the fourth frequency, respectively, and simultaneously emitted, the filtering unit 330 may perform a BPF with respect to the first emitted light received in the light receiving unit 310, using the first frequency as a center frequency. Also, the filtering unit 330 may provide the filtered light to the calculation unit 320. Also, the filtering unit 330 may filter the second emitted light to the second frequency, the third emitted light to the third frequency, and the fourth emitted light to the fourth frequency. Here, the second emitted light, the third emitted light, and the fourth emitted light may be received in the light receiving unit 310.

The BPF may be performed in parallel or sequentially. A quad configuration may be used to simultaneously filter the four frequencies. Four filters may be performed in parallel, in the quad configuration. Those skilled in the art may change a configuration of filter without departing from the principles and spirit of the disclosure.

In operation S1240, a first coordinate axis value and a second coordinate axis value of the cursor 230 on a display may be calculated.

According to exemplary embodiments, when the first emitted light and the second emitted light are received during a first half cycle, the calculation unit 320 may calculate the first coordinate axis value, that is, an x coordinate value of the cursor 230. Also, when the third emitted light and the fourth emitted light are received during a second half cycle, the calculation unit 320 may calculate the second coordinate axis value, that is, a y coordinate value of the cursor 230.

In this instance, an operation of calculating the x coordinate value of the cursor based on amplitudes of the received emitted lights has been described in detail with reference to FIG. 5, FIG. 7, and FIG. 9.

According to other exemplary embodiments, when the four emitted lights are simultaneously emitted and received, the calculation unit 320 may simultaneously calculate the first coordinate axis value and the second coordinate axis value of the cursor 230. An operation of calculating the first coordinate axis value and the second coordinate axis value based on amplitudes of the received emitted lights has been described in detail with reference to FIG. 11.

The remote pointing method according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments, or vice versa.

Although a few exemplary embodiments have been shown and described, the present disclosure is not limited to the described exemplary embodiments. Instead, it would be appreciated by those skilled in the art that changes may be made to these exemplary embodiments without departing from the principles and spirit of the disclosure, the scope of which is defined by the claims and their equivalents.

What is claimed is:

1. A remote pointing apparatus, comprising:
a light receiving unit to receive a first emitted light and a second emitted light emitted during a first half cycle, and a third emitted light and a fourth emitted light emitted during a second half cycle; and
a calculation unit to compare amplitudes of the received first emitted light and the received second emitted light to calculate a first coordinate axis value of a cursor on a display unit, and to compare amplitudes of the received third emitted light and the received fourth emitted light to calculate a second coordinate axis value of the cursor on the display unit.

2. The remote pointing apparatus of claim 1, wherein the light receiving unit receives a control signal emitted every cycle, and the calculation unit divides a cycle into the first half cycle and the second half cycle based on a time that the control signal is received.

3. The remote pointing apparatus of claim 1, wherein the first emitted light and the second emitted light have an identical cycle and an identical amplitude, and each of the first emitted light and the second emitted light is a pulse train with a first phase difference.

4. The remote pointing apparatus of claim 3, wherein the third emitted light and the fourth emitted light have an identical cycle and an identical amplitude, and each of the third emitted light and the fourth emitted light is a pulse train with a second phase difference.

5. The remote pointing apparatus of claim 1, wherein the first emitted light is a signal of a downward ramp sawtooth waveform, the second emitted light is a signal of an upward ramp sawtooth waveform, and the first emitted light and the second emitted light have an identical cycle and an identical maximum amplitude.

6. The remote pointing apparatus of claim 1, wherein the third emitted light is a signal of a downward ramp sawtooth waveform, the fourth emitted light is a signal of an upward ramp sawtooth waveform, and the third emitted light and the fourth emitted light have an identical cycle and an identical maximum amplitude.

7. The remote pointing apparatus of claim 1, wherein the first emitted light is a downward ramp pulse train signal, the second emitted light is an upward ramp pulse train signal, and the calculation unit calculates the first coordinate axis value of the cursor based on a time that intensities of the first emitted light and the second emitted light are identical.

8. The remote pointing apparatus of claim 1, wherein the third emitted light is a downward ramp pulse train signal, the fourth emitted light is an upward ramp pulse train signal, and the calculation unit calculates the second coordinate axis value of the cursor based on a time that intensities of the third emitted light and the fourth emitted light are identical.

9. A remote pointing apparatus, comprising:
a modulator to generate at least four emitted lights having a same amplitude and different frequencies; and
at least four light emitting units to emit each of the at least four emitted lights.

10. The remote pointing apparatus of claim 9, wherein the at least four emitted lights include a first emitted light, a second emitted light, a third emitted light, and a fourth emitted light, and the first emitted light and the second emitted light have a first amplitude and the third emitted light and the fourth emitted light have a second amplitude.

11. A remote pointing apparatus, comprising:
a filtering unit to filter a received signal to a first frequency component, a second frequency component, a third frequency component, and a fourth frequency component; and
a calculation unit to compare amplitudes of the first frequency component and the second frequency component to calculate a first coordinate axis value of a cursor on a display unit, and to compare amplitudes of the third frequency component and the fourth frequency component to calculate a second coordinate axis value of the cursor on the display unit.

12. A remote pointing method, comprising:
emitting a first emitted light and a second emitted light during a first half cycle;
receiving the first emitted light and the second emitted light during the first half cycle and calculating a first coordinate axis value of a cursor on a display unit;
emitting a third emitted light and a fourth emitted light during a second half cycle; and
receiving the third emitted light and the fourth emitted light during the second half cycle and calculating a second coordinate axis value of the cursor on the display unit.

13. The remote pointing method of claim 12, wherein the first emitted light and the second emitted light have an identical cycle and an identical amplitude, and each of the first emitted light and the second emitted light is a pulse train with a phase difference having a first angle.

14. The remote pointing method of claim 13, wherein the third emitted light and the fourth emitted light have an identical cycle and an identical amplitude, and each of the third emitted light and the fourth emitted light is a pulse train with a phase difference having a second angle.

15. The remote pointing method of claim 12, further comprising:
emitting a control signal every cycle,
wherein a cycle is divided into the first half cycle and the second half cycle based on a time that the control signal is received.

16. A remote pointing method, comprising:
receiving a first emitted light modulated to a first frequency, a second emitted light modulated to a second frequency, a third emitted light modulated to a third frequency, and a fourth emitted light modulated to a fourth frequency in a light receiving unit;
filtering the lights received in the light receiving unit to a first frequency component, a second frequency component, a third frequency component, and a fourth frequency component; and
comparing amplitudes of the first frequency component and the second frequency component to calculate a first coordinate axis value of a cursor on a display unit, and comparing amplitudes of the third frequency component and the fourth frequency component to calculate a second coordinate axis value of the cursor on the display unit.

17. The remote pointing method of claim 16, wherein the first emitted light and the second emitted light have a first amplitude and the third emitted light and the fourth emitted light have a second amplitude.
